(19) United States
(12) Patent Application Publication
(10) Pub. No.: US 2024/0231865 A1
(43) Pub. Date: Jul. 11, 2024

(54) APPLICATION OF AN EXPRESS DATA PATH CONFIGURATION IN A VIRTUAL COMPUTING ENVIRONMENT

(71) Applicant: VMware LLC, Palo Alto, CA (US)

(72) Inventors: Ronak Doshi, San Jose, CA (US); Cheng-Chun Tu, Sammamish, WA (US); Guolin Yang, San Jose, CA (US); Boon Seong Ang, Saratoga, CA (US); Peng Li, Fremont, CA (US)

(21) Appl. No.: 18/150,342

(22) Filed: Jan. 5, 2023

(51) Int. Cl. G06F 9/455; H04L 69/22

(52) U.S. Cl. CPC G06F 9/45533; H04L 69/22

(57) ABSTRACT

Described herein are systems, methods, and software to offload an eXpress Data Path (XDP) operation from a virtual machine to the hypervisor or smart network interface on the host. In one implementation, a method includes, in a virtual machine on a host, passing an XDP configuration for the virtual machine to a hypervisor on the host. The method further includes, in the hypervisor initiating a process to implement the XDP configuration, identifying a packet directed to the virtual machine, and applying the process to the packet to determine an action for the packet.

### BACKGROUND

In computing environments, virtual machines are deployed on hosts to use the physical resources of the host more efficiently. The resources include processing system resources (i.e., CPU resources), memory resources, storage resources, and networking resources. To support the virtual machines, a hypervisor is used to abstract the physical components of the hosts and provide each of the virtual machines with abstracted components for execution.

In some implementations, the hypervisor can further provide networking operations in association with the virtual machine, including routing, switching, firewall, or some other networking operation. The networking operations can be used to communicate packets between virtual machines on the same host, virtual machines across multiple hosts, and other computing systems. The networking operations of the hypervisor can identify addressing attributes of the packets and forward the packets based on the addressing attributes.

In some examples, guest virtual machines that are executing on a host can use eXpress Data Path (XDP) to send and receive network packets at high rates by bypassing portions of the guest's operating system network stack. XDP can be used to as a hook in the receive path of the kernel in the guest to determine an action to be taken on a particular packet. The actions can include permitting the packet, dropping the packet, return the packet to the sending network interface from which it was received, redirect the packet, or provide some other similar operation in association with the packet. An XDP configuration and corresponding rules can also be unique to each virtual NIC (VNIC) available on the virtual machine, permitting different actions for packets received at different interfaces. However, because XDP is implemented in the virtual machine, overhead occurs in moving the packet into memory associated with the virtual machine. This overhead can use additional processing resources that could otherwise be dedicated to other services on the host.

### OVERVIEW

The technology disclosed herein manages the application of an eXpress Data Path (XDP) configuration for a virtual machine. In one implementation, a method includes, in a virtual machine on a host, providing an XDP configuration for the virtual machine to a hypervisor on the host. The method further includes, in the hypervisor, initiating a process to implement the XDP configuration, identifying a packet directed to the virtual machine, and applying the process to the packet to determine an action for the packet.

In another example, a host includes a main processing system or central processing unit (CPU) and a smart network interface connector (SmartNIC) communicatively coupled to the main processing system. The SmartNIC is configured to receive a XDP configuration associated with a virtual machine from the main processing system that executes the virtual machine. The SmartNIC is further configured to initiate a process to implement the XDP configuration, identify a packet directed to the virtual machine, and apply the process to the packet to determine an action for the packet.

### BRIEF DESCRIPTION OF THE DRAWINGS

FIG. 1 illustrates a computing environment to apply an eXpress Data Path (XDP) configuration for a virtual machine according to an implementation.

FIG. 2 illustrates a method of operating a host to apply an XDP configuration for a virtual machine according to an implementation.

FIG. 3 illustrates a computing environment to apply an XDP configuration for a virtual machine in a smart network interface connector (SmartNIC) according to an implementation.

FIG. 4 illustrates a method of operating a host to apply an XDP configuration for a virtual machine in a SmartNIC according to an implementation.

FIG. 5 illustrates an operational scenario of apply an XDP configuration for a virtual machine according to an implementation.

FIG. 6 illustrates a host computing system to apply an XDP configuration for a virtual machine according to an implementation.

### DETAILED DESCRIPTION

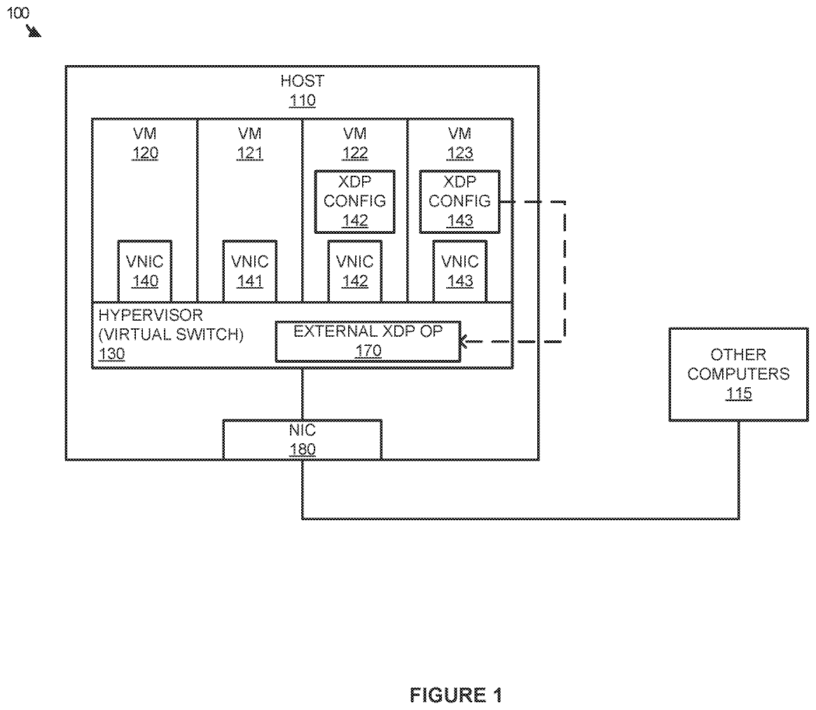

FIG. 1 illustrates a computing environment 100 to apply an eXpress Data Path (XDP) configuration for a virtual machine according to an implementation. Computing environment 100 includes host 110 and other computers 115. Host 110 further includes virtual machines 120-123, hypervisor 130, and networking interface card (NIC) 180. Virtual machines 120-123 further include virtual NICs (VNICs) 140-143, and virtual machines 122-123 further include XDP configurations 142-143. Hypervisor 130 provides external XDP operation 170. Other computers 115 can include other hosts of virtual machines, console devices, user devices, or some other computer.

In computing environment 100 host 110 executes hypervisor 130 that provides a platform for virtual machines 120-123. Hypervisor 130 abstracts the physical components of host 110 and provides the abstracted components to the virtual machines. The abstracted components can include processing resources, memory resources, storage resources, and networking resources. Here, each virtual machine is provided with a VNIC of VNICs 140-143 that provide networking connectivity for virtual machines 120-123. VNICs 140-143 are coupled to a virtual switch provided by hypervisor 130 that can be used to provide a variety of networking functions, including switching, routing, firewall application and the like. The virtual switch can direct packets between virtual machines on the same host and can further direct packets over NIC 180 to other computers 115.

As further demonstrated in computing environment 100, virtual machines can include an XDP configuration that defines rules for processing packets directed to the virtual machines. XDP is a framework for executing Extended Berkeley Packet Filter (eBPF) programs, which safely run inside a Linux kernel. XDP programs can increase packet rates by bypassing portions of the operating system network stack or provide the operations on a packet prior to the packet being placed in a portion of the network stack. The XDP operations can be used to pass the packet through to the network stack of the operating system, drop the packet, return the packet back to the network interface on which the packet was received, redirect the packet, or provide some other operation. The XDP operations can be performed based on any information in the tuple of the packet, wherein the information can include source and destination IP addresses, MAC addresses, ports, or some other information in the packet. In the present example, rather than providing the XDP functionality in the virtual machine, the XDP configuration is passed to the hypervisor, permitting the hypervisor to perform the same functionality.

As an example, virtual machine 123 includes XDP configuration 143, wherein the configuration can be generated by an administrator or user associated with virtual machine 123. During the startup or execution of virtual machine 123, virtual machine 123 passes or communicates XDP configuration 143 to hypervisor 130. In some examples, virtual machine 123 can pass the configuration using a para-virtual network driver, such as vmxnet3, which provides integration with hypervisor 130 to process packets more efficiently. After providing

XDP configuration 143, hypervisor 130 executes a process to implement the XDP operations in hypervisor 130, permitting actions to be taken on a packet prior providing the packet to the network stack via VNIC 143. For example, when a packet is directed to VNIC 143, hypervisor 143 can identify information in the header of the packet (e.g., addressing information) and compare the information to the rules in XDP configuration 143. Hypervisor 143 can then apply an action with a corresponding rule to the packet, such as blocking a packet or forwarding the packet to the destination virtual machine.

It should be understood that references to “the packet” herein does not necessarily refer to the packet as a whole but might refer to a packet descriptor, metadata, and/or other packet information that may include header information from a packet and a location of the packet's contents, which may reside in the physical NIC or be copied via a direct memory access (DMA) operation to the host memory or a memory space shared between the host and the destination guest.

Although demonstrated in the example of computing environment 100 as implementing the action in the hypervisor, some hosts can use a SmartNIC of the host to offload the process for the XDP configuration. A SmartNIC is a programmable network interface that can implement various network functionality for the host. In at least one example, the virtual machine can pass the XDP configuration to the hypervisor that in turn programs the SmartNIC to support the XDP configuration. In other examples, a driver of the virtual machine can pass the XDP configuration directly to the SmartNIC, permitting the SmartNIC to perform the desired operations.

The XDP configuration passed from a virtual machine can be unique to each VNIC of the virtual machine. Thus, although not demonstrated in computing environment 100 as using multiple VNICs, different VNICs for a virtual machine can be allocated a different XDP configuration. Alternatively, a first NIC can be allocated a XDP configuration, while a second NIC is not allocated an XDP configuration. The configurations for each of the NICs can be assigned by a user or administrator associated with the virtual machine.

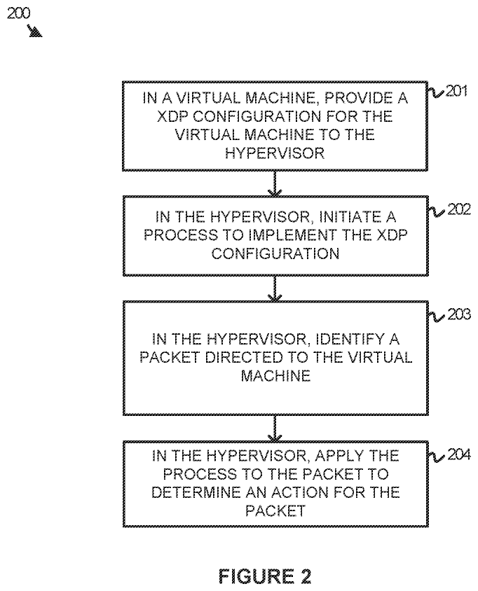

FIG. 2 illustrates a method 200 of operating a host to apply an XDP configuration for a virtual machine according to an implementation. The steps of method 200 are referenced parenthetically in the paragraphs that follow with reference to systems and elements of computing environment 100. Although demonstrated in the example using virtual machine 123, similar operations can be performed for other virtual machines on host 110.

Method 200 includes, in a virtual machine on the host, passing (201) an XDP configuration for the virtual machine to a hypervisor on the host. In some examples, the XDP configuration can be passed to the hypervisor using para-virtual network driver, such as a version of a vmxnet driver. Method 200 further includes, in the hypervisor, initiating (202) a process to implement the XDP configuration, identifying (203) a packet directed to a VNIC for the virtual machine, and applying (204) the process to the packet to determine an action for the packet.

In some implementations, the XDP configuration can comprise code and/or data structures that indicate rules for ingress packets associated with the VNIC of the virtual machine. The rules can associate header information or tuple information from a packet with a corresponding action. The actions can include permitting the packet to be forwarded to the network stack of the virtual machine, blocking the packet, performing a redirect of the packet, or providing some other operation in association with the packet.

Using the example of virtual machine 123, virtual machine 123 passes XDP configuration 143 to hypervisor 130 and hypervisor 130 initiates a process to implement the XDP configuration (demonstrated as external XDP operation 170). After initiating external XDP operation 170, hypervisor 130 identifies a packet directed to VNIC 143, e.g., by examining the destination address from the packet header. Hypervisor 130 uses external XDP operation 170 to compare header information from the packet to the rules set for in XDP configuration 143 and determines an action for the packet. If the packet is permitted, the packet can be forwarded to VNIC 143 and processed using the operating system stack of virtual machine 123. If not permitted, hypervisor 130 can block the packet or redirect the packet per the definitions in XDP configuration 143.

In at least one implementation, only a portion of the XDP operations can be executed in the hypervisor. For example, a redirect operation may require addressing and other modifications to be made in the header of the packet and may require the packet to be sent out of an alternative network interface. Accordingly, virtual machine 123 may perform additional XDP operations that cannot be performed externally by hypervisor 130. In some examples, hypervisor 130 may set a flag in a packet when a rule has been applied by the hypervisor, permitting virtual machine 123 to identify the packet and take any additional corresponding actions (e.g., redirect the packet).

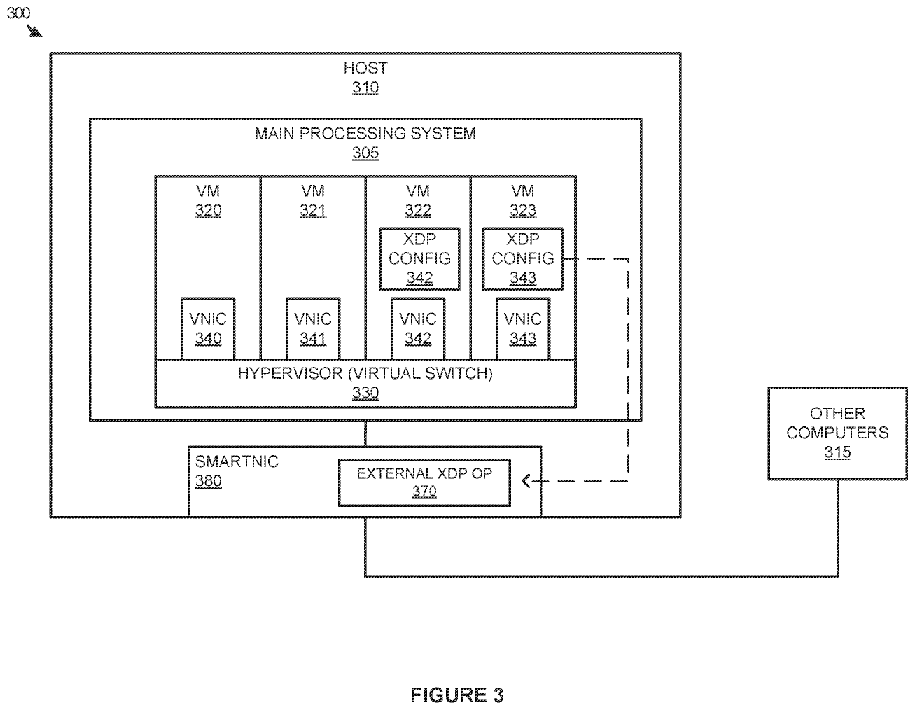

FIG. 3 illustrates a computing environment 300 to apply an XDP configuration for a virtual machine in a smart network interface connector (SmartNIC) according to an implementation. Computing environment 300 includes host 310 and other computers 315. Host 310 includes main processing system 305 and SmartNIC 380, wherein each of main processing system 305 and SmartNIC 380 can include processing circuitry and memory. Main processing system 305 can represent one or more central processing units (CPUs) and memory/storage available to the one or more CPUs. Main processing system 305 further includes hypervisor 330 and virtual machines 320-323. Virtual machines 320-323 include VNICs 340-343 and virtual machines 322-323 further include XDP configurations 342-343. SmartNIC 380 is configured to provide external XDP operation 470.

In computing environment 300, main processing system 305 executes hypervisor 330 that provides a platform for virtual machines 320-323. Hypervisor 330 can be used abstract the physical components of host 310 and provide the abstracted components to each virtual machine of virtual machines 320-323. To support the execution of the virtual machines, one or more virtual machines of virtual machines 320-323 can offload an XDP process to SmartNIC 380. In at least one implementation, during startup or execution of virtual machines 322-323, virtual machines 322-323 can pass the corresponding XDP configuration of XDP configurations 342-343 to hypervisor 330. Once passed to hypervisor 330, hypervisor 330 can configure SmartNIC 380 to implement the corresponding configuration. In at least one example, virtual machines 322-323 can pass XDP configurations 342-343 using a para-virtual network driver. Once passed to hypervisor 330, hypervisor 330 can communicate and configure SmartNIC 380 to implement the XDP operation as part of external XDP operation 370.

After configuring SmartNIC 380, SmartNIC 380 receives a packet from a computer of other computers 315 that is directed to VNIC 343 for virtual machine 323. When received, external XDP operation 370 is applied to the packet to determine an action for the packet. The actions can include blocking the packet, permitting the packet, redirecting the packet, or providing some other operation in association with the packet. For example, the addressing in the packet can be compared in the rules for the XDP configuration and an action can be identified that blocks the packet. Thus, prior to processing the packet in the virtual machine, the packet can be processed and blocked using the hypervisor of the host.

In some examples, a portion of the XDP processing will be implemented at least partially in the virtual machine. These operations can include modifying the packet and directing the packet out via another VNIC on the virtual machine. Accordingly, a first portion of the operations can be implemented using the SmartNIC and a second portion of the operations can be implemented in the virtual machine. In some examples, packets that are processed via the external XDP operation can have a flag set in the packet indicating that no further processing is required within the virtual machine or, in the alternative, that additional processing is required in the virtual machine.

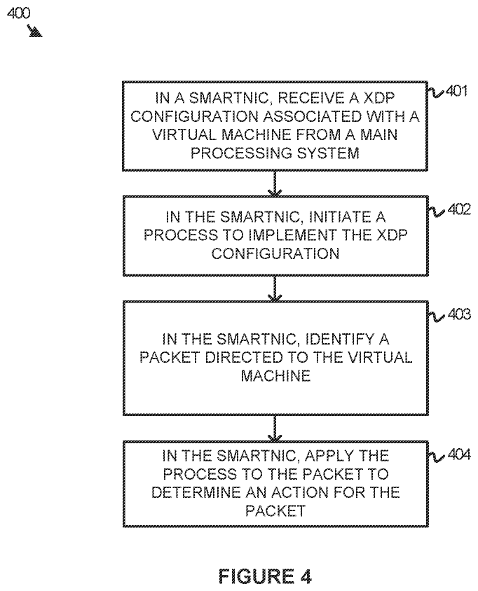

FIG. 4 illustrates a method 400 of operating a host to apply an XDP configuration for a virtual machine in a SmartNIC according to an implementation. The steps of operation 400 are referenced parenthetically in the paragraphs that follow with reference to systems and elements of computing environment 300 of FIG. 3.

Method 400 includes receiving (401) an XDP configuration for a virtual machine executing on the main processing system. In some implementations, the SmartNIC is coupled to the main processing system via a bus and both the SmartNIC and the main processing system can include processing circuitry and memory that stores instructions and data for processing by the corresponding circuitry. As an example, virtual machine 323 can pass the XDP configuration 343 to hypervisor 330 using a para-virtual network driver. Once passed to hypervisor 330, hypervisor 330 can communicate the configuration to SmartNIC 380. As another example, virtual machine 323 can directly pass the XDP configuration 343 using an agent or other software element to SmartNIC 380.

Once the XDP configuration is received by the SmartNIC, method 400 further includes initiating (402) a process to implement the XDP configuration, identifying (403) a packet directed to the virtual machine, and applying (404) the process to the packet to determine an action for the packet. The process can be used to block the packet, pass the packet through the VNIC, or provide some other operation in association with the packet.

In some examples, first XDP operations that are executed in the SmartNIC, while second XDP operations are executed in the virtual machine. The XDP operations in the virtual machine can be used to modify the addressing of the packet, direct the packet out of another VNIC, or provide some other operation. Thus, if a XDP operation does not apply in the

SmartNIC, the SmartNIC will forward the packet to the virtual machine to provide additional XDP operations. Additionally, when external XDP operation 370 does include an action for the packet, the packet can be flagged, permitting virtual machine 323 to identify that the packet has been processed.

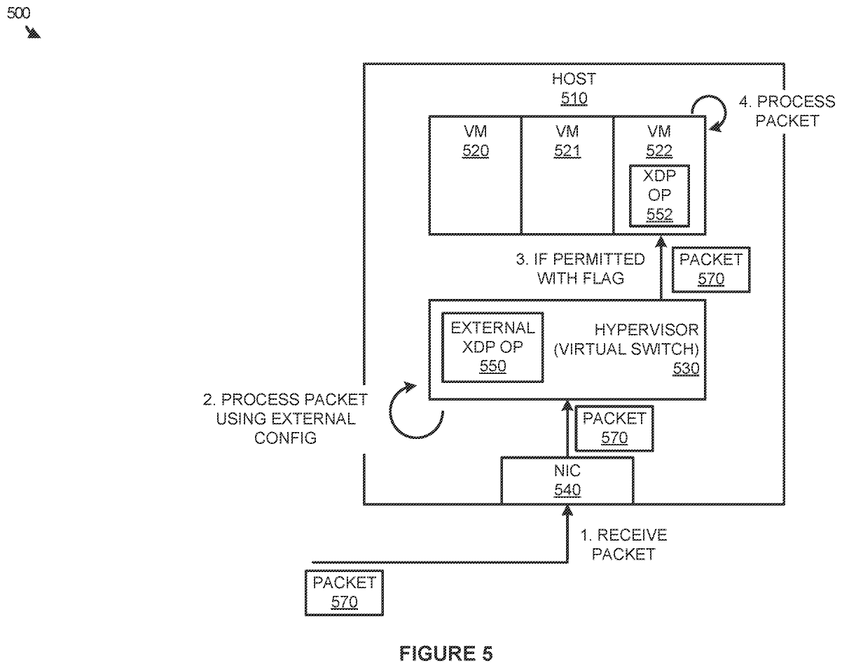

FIG. 5 illustrates an operational scenario 500 of apply an XDP configuration for a virtual machine according to an implementation. Operational scenario 500 includes host 510 and packet 570. Host 510 further includes virtual machines 520-522, XDP operation 552, hypervisor 530, external XDP operation 550, and NIC 540.

In operational scenario 500, host 510 receives, at step 1, packet 570 at NIC 540 and packet 570 is in turn forwarded to hypervisor 530. Hypervisor 530 implements external XDP operation 550 in kernel space based on configuration information provided from virtual machine 522. External XDP operation 550 can be used to block, permit, or provide some other operation in association with packet 570. Here, at step 2, hypervisor 530 and external XDP operation 550 processes the packet using the configuration information from virtual machine 522. In processing the packet, hypervisor 530 determines, at step 3, that the packet includes attributes that qualify for a rule that sets a flag in packet 570, wherein that the packet completed processing in hypervisor 530 or that additional processing is required by the virtual machine. After the flag is set, packet 570 is forwarded to virtual machine 522, wherein virtual machine 522 can process the packet using additional XDP operation 552 at step 4. The additional XDP operations can be used to take actions on packets that may not necessarily be implemented in hypervisor 530.

As an illustrative example, packet 570 can include attributes that correspond to an XDP rule that redirects the packet out of a second VNIC for the virtual machine. The attributes can include tuple information, such as source and destination IP addresses, source and destination ports, protocol, or some other attributes from the header. Rather than implementing the operation in hypervisor 530, hypervisor 530 can generate a flag that indicates that the packet requires additional processing in virtual machine 522 and forward the packet to the corresponding VNIC for virtual machine 522. XDP operation 522 then processes the packet to redirect the packet out another VNIC. The redirect operation can be used to modify one or more attributes in the packet, including addressing in the header of the packet prior to forwarding the packet toward the destination. For example, virtual machine 522 can replace the destination IP address of the packet prior to communicating the packet using another VNIC.

While the example of operational scenario 500 permits XDP operations to be performed both internally and externally from a virtual machine 522, the XDP operations can be performed entirely outside of virtual machine 522. Virtual machine 522 can pass the XDP configuration to hypervisor 530, permitting hypervisor 530 to implement external XDP operation 550 with the corresponding XDP configuration.

Although demonstrated as implementing the operations in the hypervisor, similar operations can be performed by a SmartNIC that can offload at least a portion of the logical networking otherwise provided by the hypervisor. The SmartNIC is coupled to a main processing system of a host via a bus, wherein the SmartNIC can include one or more processors and memory to implement the desired networking operations. In at least one example, virtual machine 522 can communicate XDP configuration information to hypervisor 530 via a para-virtual network driver. The hypervisor can then configure the SmartNIC to initiate a process that implements the XDP configuration. Alternatively, a driver or other agent in the virtual machine can communicate directly to the SmartNIC to provide the configuration information to be applied in the SmartNIC.

Although demonstrated in the example, of operational scenario 500 as receiving a packet at a physical NIC 540, similar operations can be employed for packets from other virtual machines on host 510. For example, a packet communicated from virtual machine 520 to virtual machine 522 can be processed using external XDP operation 550. Hypervisor 530 can identify the destination for the packet as corresponding to a VNIC on virtual machine 522 and can process the packet using the XDP associated with the destination VNIC. Advantageously, like packets received at the physical network interface, packets from locally executing virtual machines can be processed using the XDP configuration.

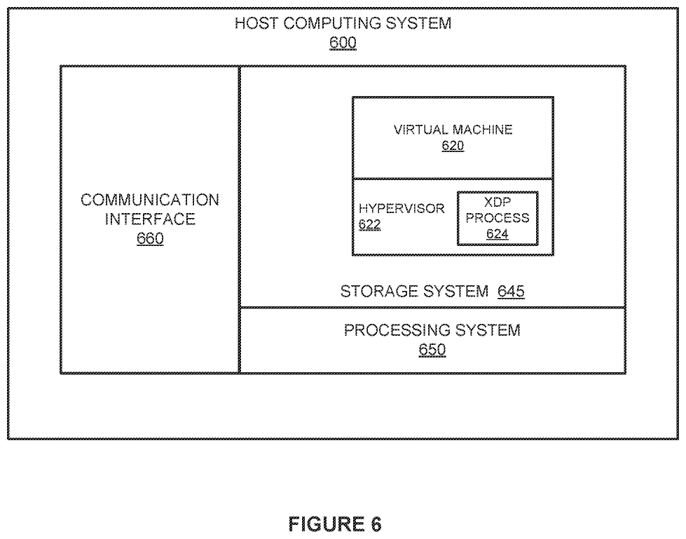

FIG. 6 illustrates a host computing system 600 to apply an XDP configuration for a virtual machine according to an implementation. Host computing system 600 is representative of any computing system or systems with which the various operational architectures, processes, scenarios, and sequences disclosed herein for a host can be implemented. Host computing system 600 is an example of host 110 of FIG. 1 and host 310 of FIG. 3, although other examples may exist. Host computing system 600 includes storage system 645, processing system 650, and communication interface 660. Processing system 650 is operatively linked to communication interface 660 and storage system 645. Communication interface 660 may be communicatively linked to storage system 645 in some implementations. Host computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format - including combinations thereof. Communication interface 660 may be configured to communicate with other hosts and computing systems in the same data center or across multiple data centers. In some examples, communication interface 660 can represent a SmartNIC that can implement logical network operations for the host and offloading at least a portion of the processing from processing system 650. In at least one example, the combination of processing system 650 and storage system 645 can represent a main processing system, while communication interface 660 can represent a SmartNIC with processing circuitry and memory to implement the logical networking operations.

Processing system 650 comprises microprocessor and other circuitry that retrieves and executes operating software from storage system 645. Storage system 645 may include volatile and nonvolatile, removable, and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises virtual machine 620, hypervisor 622, and XDP process 624. The operating software on storage system 645 may further include an operating system, utilities, drivers, network interfaces, applications, or some other type of software. When read and executed by processing system 650 the operating software on storage system 645 directs host computing system 600 to operate as a host described herein in FIG. 1-5.

In at least one implementation, hypervisor 622 directs processing system 650 to provide a platform for the execution of virtual machine 620 by providing abstracted processing, memory, storage, networking, and other resources. Virtual machine 620 includes its own operating system and processes to perform desired operations, wherein the operations can include database operations, data processing operations, front-end services operations, or some other operations. Here, virtual machine 620 can be allocated an XDP configuration, wherein XDP can increase packet rates by bypassing portions of the operating system network stack or provide the operations on a packet prior to the packet being placed in a portion of the network stack. Rather than implementing the XDP configuration as part of a process within virtual machine 620, virtual machine 620 passes the XDP configuration to hypervisor 622. In some implementations, to pass the XDP configuration, virtual machine 620 can use a para-virtual network driver, such as vmxnet3, to pass the information to hypervisor 622. However, the XDP configuration can be communicated to hypervisor 622 using any other agent or driver capable of communicating externally with hypervisor 622.

Hypervisor 622, after receiving the XDP configuration, directs processing system 650 to initiate XDP process 624 to implement the XDP configuration. XDP process 624 can be used to block packets directed to a VNIC on virtual machine 620, permit packets directed to a VNIC on virtual machine 620, redirect the packet, or provide some other operation in association with the packet. For example, the XDP configuration provided by virtual machine 620 for a VNIC on virtual machine 620 can permit packets that include one or more addressing attributes in the tuple for the packet (e.g., source/destination IP addresses, source/destination ports, etc.). When a packet is received with the one or more attributes, hypervisor 622 can identify the corresponding rule and forward the packet to the VNIC for the virtual machine. Thus, rather than using the processing resources of the virtual machine to implement an XDP operation, the XDP operation can be implemented in the hypervisor.

In some implementations, rather than implementing the XDP operation in hypervisor 622, the XDP configuration associated with virtual machine 620 can be offloaded to communication interface 660 when communication interface 660 represents a SmartNIC. SmartNIC 660 can include processing circuitry and memory to implement networking operations for hypervisor 622, wherein the networking operations can include firewalls, logical switching, and routing, or some other operation. In at least one example, virtual machine 620 can pass the configuration hypervisor 622 using an agent or driver on virtual machine 620. Hypervisor 622 then directs processing system 650 to pass the configuration to communication interface 660 to implement the configuration.

When a packet is received at the physical interface for communication interface 660, communication interface 660 can perform packet inspection to identify attributes in the packet and identify a rule in the configuration that applies to attributes. From the rule, communication interface 660 can perform an action on the packet (e.g., permit, block, etc.).

When permitted, the packet can be forwarded to the NIC of virtual machine 620, permitting local processes of virtual machine 620 to process the packet. Although demonstrated as receiving the packet at the external interface, communication interface 660 can also process packets between virtual machines on the same host. Thus, when a packet is communicated from a second virtual machine to virtual machine 620, the XDP configuration can be applied to the packet to determine an action associated with the packet.

In some implementations, at least a portion of the XDP operations for virtual machine 620 cannot be implemented using hypervisor 622. For example, an XDP configuration for virtual machine 620 and a first VNIC can receive a packet and redirect the packet out of another VNIC for the same virtual machine. Thus, a first portion of the XDP operations can be implemented outside of the virtual machine (in hypervisor 622 or communication interface 660), while a second portion of the XDP operations can be implemented in virtual machine 620.

In at least one example, when first XDP operations are applied to a packet externally from the virtual machine, the XDP operations can set a flag indicating that additional processing is required, or no additional processing is required in association with the packet. For example, if a redirect action is to be taken on a packet, XDP process 624 can direct processing system 650 to set a flag in the packet and forward the packet to the corresponding VNIC of virtual machine 620. In response to receiving the packet, virtual machine 620 can provide additional operations on the packet, such as modifying addressing in the header of the packet and communicate the packet via a second VNIC of virtual machine 620.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in a virtual machine on a host, passing an eXpress Data Path (XDP) configuration for the virtual machine to a hypervisor on the host;
in the hypervisor, initiating a process to implement the XDP configuration;
in the hypervisor, identifying a packet directed to the virtual machine; and
in the hypervisor, applying the process to the packet to determine an action for the packet.

2. The method of claim 1,
wherein the action comprises a permit action; and
wherein the method further comprises, in the hypervisor, forwarding the packet to virtual network interface for the virtual machine.

3. The method of claim 1,
wherein the action comprises a block action; and
wherein the method further comprises, in the hypervisor, blocking the packet to the virtual network interface for the virtual machine.

4. The method of claim 1, wherein providing the XDP configuration for the virtual machine to the hypervisor comprises providing the XDP configuration via a para-virtual network driver.

5. The method of claim 1,
wherein the action comprises an action to forward the packet to the virtual machine; and
in the hypervisor, setting a flag in the packet to indicate an XDP action was taken by the hypervisor.

6. The method of claim 1, wherein the action comprises a redirect action to direct the packet to a different destination.

7. The method of claim 1 further comprising:
in a second virtual machine on the host, passing a second XDP configuration for the second virtual machine to the hypervisor;
in the hypervisor, initiating a second process to implement the second XDP configuration;
in the hypervisor, identifying a second packet directed to the second virtual machine; and
in the hypervisor, applying the second process to the second packet to determine an action for the second packet.

8. A computing apparatus comprising:
a storage system;
a processing system communicatively coupled to the storage system; and
program instructions stored on the storage system that, when executed by the processing system, direct the computing apparatus to:
in a virtual machine on a host, pass an eXpress Data Path (XDP) configuration for the virtual machine to a hypervisor on the host;
in the hypervisor, initiate process to implement the XDP configuration;
in the hypervisor, identify a packet directed to the virtual machine; and
in the hypervisor, apply the process to the packet to determine an action for the packet.

9. The computing apparatus of claim 8,
wherein the action comprises a permit action; and
wherein the program instructions further direct the computing apparatus to forward the packet to virtual network interface for the virtual machine.

10. The computing apparatus of claim 8,
wherein the action comprises a block action; and
wherein the program instructions further direct the computing apparatus to block the packet to the virtual network interface for the virtual machine.

11. The computing apparatus of claim 8, wherein providing the XDP configuration for the virtual machine to the hypervisor comprises providing the XDP configuration via a para-virtual network driver.

12. The computing apparatus of claim 8,
wherein the action comprises an action to forward the packet to the virtual machine; and
wherein the program instructions further direct the computing apparatus to, in the hypervisor, set a flag in the packet to indicate an XDP action was taken by the hypervisor.

13. The computing apparatus of claim 8, wherein the action comprises a redirect action to direct the packet to a different destination.

14. The computing apparatus of claim 8, wherein the program instructions further direct the computing apparatus to:
in a second virtual machine on the host, pass a second XDP configuration for the second virtual machine to the hypervisor;
in the hypervisor, initiate a second process to implement the second XDP configuration;
in the hypervisor, identify a second packet directed to the second virtual machine; and
in the hypervisor, apply the second process to the second packet to determine an action for the second packet.

15. A system comprising:
a main processing system; and
a smart network interface connector (SmartNIC) communicatively coupled to the main processing system and configured to:
receive an eXpress Data Path (XDP) configuration for a virtual machine executing on the main processing system;
initiate a process to implement the XDP configuration;
identify a packet directed to the virtual machine; and
apply the process to the packet to determine an action for the packet.

16. The system of claim 15,
wherein the action comprises a permit action; and
wherein the SmartNIC is further configured to forward the packet to the virtual network interface for the virtual machine.

17. The system of claim 15,
wherein the action comprises a deny action; and
wherein the SmartNIC is further configured to block the packet to the virtual network interface for the virtual machine.

18. The system of claim 15, wherein providing the XDP configuration for the virtual machine to the hypervisor comprises providing the XDP configuration via a para-virtual network driver.

19. The system of claim 15,
wherein the action comprises an action to forward the packet to the virtual machine; and
wherein the SmartNIC is further configured to set a flag in the packet to indicate an XDP action was taken in the SmartNIC.

20. The system of claim 15, wherein the action comprises a redirect action to direct a packet to a different destination.
